(19) United States
(12) Patent Application Publication
(10) Pub. No.: US 2019/0229321 A1
(43) Pub. Date: Jul. 25, 2019

(54) ELECTRODE-ASSEMBLY AND BATTERY

(71) Applicant: Ningde Amperex Technology Limited, Ningde (CN)

(72) Inventors: Zuchao Liu, Ningde (CN); Chuantao Song, Ningde (CN); Zhiwen Xiao, Ningde (CN); Haiyang Nan, Ningde (CN); Wei Huang, Ningde (CN); Xinru Su, Ningde (CN)

(21) Appl. No.: 16/182,595

(22) Filed: Nov. 6, 2018

(30) Foreign Application Priority Data
Jan. 23, 2018 (CN) 201810065466.8

(51) Int. Cl. H01M 2/34; H01M 10/42; H01M 2/26

(52) U.S. Cl. CPC H01M 2/348; H01M 10/425; H01M 2010/4271; H01M 2200/103; H01M 2/26

(57) ABSTRACT

The present application relates to the field of battery, discloses an electrode-assembly and a battery, wherein the electrode-assembly includes a body with a first wall and a current blocker arranged on the first wall. The first wall of the body is close to the internal structure of the body, and its temperature is relatively close to the internal temperature of the body as compared with the seal side of the electrode-assembly; in above electrode-assembly, since the current blocker is directly attached to the first wall of the body, the heat inside the body can be quickly conducted to the current blocker through the first wall, so the current blocker of the electrode-assembly can be triggered more timely to reduce or cut off the current for effectively protecting the electrode-assembly.

### PRIORITY CLAIM AND CROSS-REFERENCE

This application claims priority to and benefits of Chinese Patent Application Serial No. 201810065466.8 filed with China National Intellectual Property Administration on Jan. 23, 2018, entitled “ELECTRODE-ASSEMBLY AND BATTERY”, and the entire content of which is incorporated herein by reference.

### FIELD OF THE APPLICATION

The application relates to field of battery, in particular, to an electrode-assembly and a battery.

### BACKGROUND OF THE APPLICATION

In the prior art, a body of the electrode-assembly in electrode-assembly structure is generally connected in series with a current blocker. When the body of the electrode-assembly is abnormally heated, the current blocker can cut off or greatly reduce the charge and discharge current of the body of the electrode-assembly, thereby protecting the electrode-assembly. At present, the current blocker is generally adhered to a seal side of the body of the electrode-assembly by a double-sided tape, and is connected to the electrode tab of the electrode-assembly through a connection terminal and a connecting sheet, thereby achieving series connection with the body of the electrode-assembly. However, the current common problem is that the current blocker has a trigger (cut or greatly reduce the current) action with a long delay. Therefore, it is often the case that the temperature of the body of the electrode-assembly has risen abnormally, the current blocker does not operate still, or when the current blocker is in operation, the body of the electrode-assembly has reached the overcharge state, and the current blocker does not function to protect the electrode-assembly.

### SUMMARY OF THE APPLICATION

The present application discloses an electrode-assembly and a battery, which are used to improve the protection function of the current blocker to electrode-assembly.

In order to achieve above purpose, the present application provides the following solutions:

an electrode-assembly, including:

a body including a first wall and a first side, the first side is adjacent to the first wall; and a current blacker arranged on the first wall.

The first wall is close to the internal structure of the body, and the temperature of the first wall is relatively close to the internal temperature of the body as compared with the seal side of the electrode-assembly; in above electrode-assembly, since the current blocker is arranged on the first wall of the body, the heat inside the body may be quickly conducted to the current blocker through the first wall, so the current blocker of the electrode-assembly can be triggered in a more timely manner to reduce or cut off the current for effectively protecting the electrode-assembly.

Alternatively, the current blocker includes a housing, and an opening of the housing faces the first wall.

Alternatively, the current blocker is adhered to the first wall.

Alternatively, the body further includes a first electrode tab; the first electrode tab protrudes from the first side; and the current blocker is coupled to the first electrode tab.

Alternatively, the first electrode tab is adhered to at least one of the first wall and the first side.

Alternatively, the current blocker is triggered at a first temperature to reduce a current passing through; a product of the length of the path of the current blocker coupled to the first electrode tab and a cooling coefficient of the path is smaller than a difference between a second temperature of the first electrode tab and the first temperature.

Alternatively, the current blocker is directly electrically connected to the first electrode tab.

Alternatively, the electrode-assembly further includes a first connection terminal, the current blocker is electrically connected to the first connection terminal, and the first connection terminal is electrically connected to the first electrode tab.

Alternatively, the electrode-assembly further includes a connecting sheet, the first connection terminal is electrically connected to the connecting sheet, and the connecting sheet is electrically connected to the first electrode tab.

Alternatively, the path of the current blocker to the first electrode tab is connected by welding, and the weld area of each weld zone is not less than 10% of the overlap area of the two weld bodies in the weld zone.

Alternatively, the materials of the first connection terminal and the connecting sheet are copper materials.

Alternatively, the surfaces of the first connection terminal and the connecting sheet are coated with at least one of carbite, graphite, and silicon material.

Alternatively, at least one of an outer portion of the first connection terminal, an outer portion of the connecting sheet, and an outer portion of the first electrode tab is covered with a porous material layer.

A battery, including a circuit protection board and the electrode-assembly according to any one of above technical solutions.

### BRIEF DESCRIPTION OF THE ACCOMPANYING DRAWINGS

FIG. 1 is a structure view of an electrode-assembly provided by an example of the present application;

FIG. 2 is a structure view of an electrode-assembly provided by another example of the present application;

FIG. 3 is a structure view of an electrode-assembly provided by another example of the present application;

FIG. 4 is a top structure view of an electrode-assembly provided by another example of the present application.

### DETAILED DESCRIPTION OF THE PREFERRED EXAMPLES

The technical solutions in the examples of the present application will be clearly and completely described hereinafter in connection with the drawings in the examples of the present application. It is apparent that the described examples are only a part of the examples of the present application, but not the whole. Based on the examples of the present application, all the other examples obtained by those of ordinary skill in the art without inventive effort are within the scope of the present application.

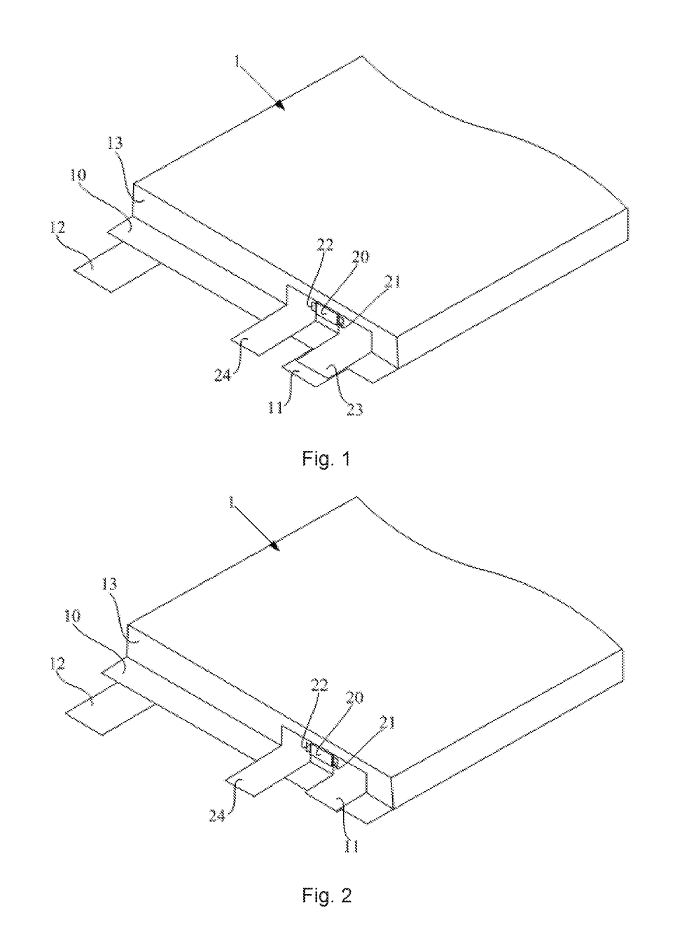

As shown in FIGS. 1 to 4, an electrode-assembly provided by examples of the present application includes a body 1 and a current blocker 20.

The body 1 includes a first wall 13 and a first side 10, and the first side 10 is adjacent to the first wall 13. In one embodiment, the the first side 10 is perpendicularly connected to the first wall 13.

The current blocker 20 is arranged on the first wall 13; specifically, the current blocker 20 is connected in series with the body 1, and once a temperature of the current blocker 20 reaches a certain temperature value, the current blocker 20 is triggered, and then the current blocker 20 is able to cut or reduce the current passing therethrough; specifically, the certain temperature value belongs to a characteristic parameter of the current blocker 20 itself.

The first wall 13 of the body 1 is close to the internal structure of the body 1, and the temperature of the first wall 13 is relatively close to the internal temperature of the body 1 as compared with the seal side of the electrode-assembly; in above electrode-assembly, since the current blocker 20 is arranged on the first wall 13 of the body 1, the heat inside the body 1 may be quickly conducted to the current blocker 20 through the first wall 13, so the current blocker 20 of the electrode-assembly may be triggered in a more timely manner to reduce or cut off the passing current for effectively protecting the electrode-assembly.

In a specific example, the current blocker 20 is fixed to the body 1 by an insulating bonding member.

Specifically, the insulating bonding member may include one or more double-sided tapes, glues or tapes. For example, as shown in FIG. 4, the insulating bonding member may include a double-sided tape 3 and a tape 4, wherein the double-sided tape 3 is located between the body 1 and the current blocker 20, and the current blocker 20 is located between the double-sided tape 3 and the tape 4.

Alternatively, a heat conductive medium layer may be arranged in the double-sided tape 3 and the tape 4. The heat conductive medium layer may be selected from materials having high heat conduction efficiency and good insulating properties, such as a metal oxide material, a carbide material, or a nitride material.

Specifically, the heat conductive medium layer may be at least one selected from a group consisting of Al₂O₃, MgO, ZnO, SiO2, BeO, BN, AlN, Si₃N₄ and SIC.

As shown in FIGS. 1 to 4, in a specific example, the body 1 further includes a first electrode tab 11; and the current blocker 20 is coupled to the first electrode tab 11.

The body 1 may include an cell, an electrolyte, and a package housing. Both the cell and the electrolyte are arranged in the package housing. The electrolyte may be an electrolytic solution or a solid electrolyte. The cell includes a positive electrode, a negative electrode, and a separator, and the separator is arranged between the positive electrode and the negative electrode. The cell may be a wound cell formed by winding a positive electrode, a negative electrode, and a separator, or a laminated cell formed by stacking a positive electrode, a negative electrode, and a separator. The first electrode tab 11 is arranged on one of the electrode of the cell, and may be arranged on the positive electrode or on the negative electrode.

As shown in FIGS. 1 to 4, in a specific example of the present application, the first side 10 may be a seal side formed by a sealing of the package film, and the first electrode tab 11 protrudes from the first side 10; optionally, the first side 10 and the first wall 13 are both located at the top of the body 1, and the first side 10 is adjacent to the first wall 13.

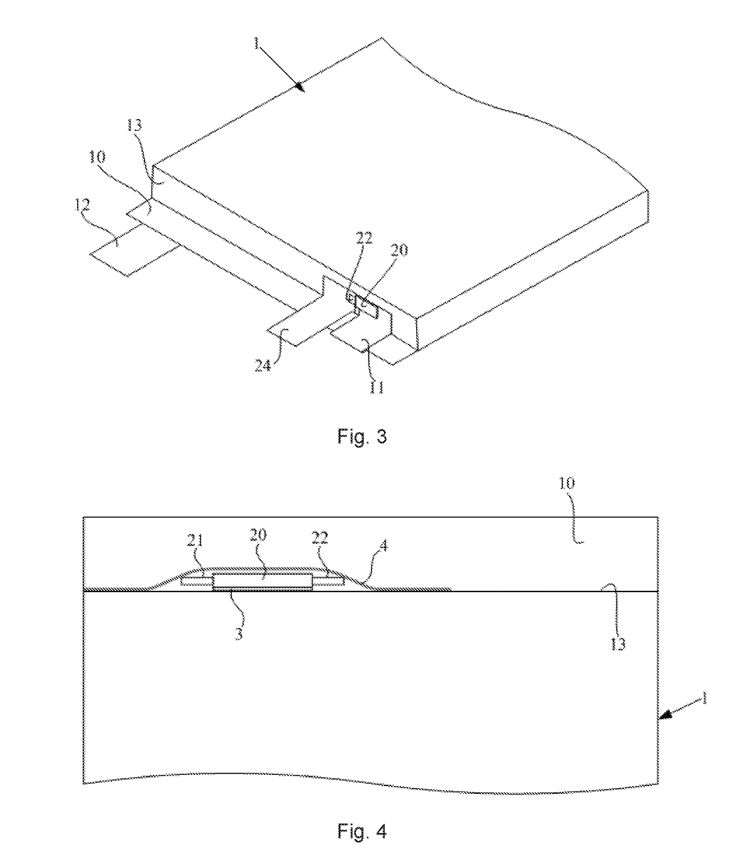

Specifically, as shown in FIGS. 2 and 3, the first electrode tab 11 may be adhered to the first wall 13; and the first electrode tab 11 is also adhered to the first side 10.

Affixing the first electrode tab 11 to the first wall 13 and the first side 10 improves the stability of the current blacker 11 on the first wall 13 and reduces the heat loss of the first wall 13 and the first electrode tab 11, thereby ensuring the heat conduction efficiency of the body 1 to the current blocker 20.

In a specific example, the body 1 further includes a second electrode tab 12, and the polarity of the second electrode tab 12 is opposite to that of the first electrode tab 11. The second electrode tab 12 protrudes from the first side 10 and is used to connect with an external electrical device, specifically; the first electrode tab 11, the current blocker 20, the external electrical device, and the second electrode tab 12 are connected to form a current path, which is the charge and discharge circuit of the body 1.

In a specific example, a product of a length of the connecting path from the current blocker 20 to the first electrode tab 11 and a cooling coefficient of the connecting path is smaller than a difference between a second temperature of the first electrode tab 11 and a first temperature of the current blocker 20; wherein the second temperature of the first electrode tab 11 is the temperature of the first electrode tab 11 when the body 1 is overcharged, and the first temperature of the current blocker 20 is the temperature of the current blocker 20 when the current blocker 20 is triggered; specifically, overcharge refers to a critical state in which the temperature of the electrode-assembly body 1 rises to a combustion or explosion reaction.

Specifically, assuming that T₂ is the second temperature of the first electrode tab 11, T₁ is the first temperature of the current blocker 20, L is the length of a connecting path from the current blocker 20 to the first electrode tab 11, α is the cooling coefficient of a connecting path from the current blocker 20 to the first electrode tab 11, above electrode-assembly satisfies the formula of: L·α<(T₂−T₁), i.e. satisfies. T₁+L·α<T₂, wherein T₂ is the temperature of the first electrode tab 11 when the body 1 is overcharged, T₁ is the temperature of the current blocker 20 when the current blocker 20 is triggered, then T₁+L·α is the temperature of the first electrode tab 11 when the current blocker 20 is triggered, further the formula T₁+L·α<T₂ indicates that the electrode-assembly satisfies: the temperature of the first electrode tab 11 when the current blacker 20 is triggered is less than the temperature of the first electrode tab 11 when the body 1 is overcharged, that is, the current blocker 20 has been triggered before the body 1 is overcharged. In summary, in the above-mentioned electrode-assembly, the triggering action of the current blocker 20 is relatively timely, and the body 1 may be prevented from reaching the overcharge state. Further, the current blocker 20 in the above-mentioned electrode-assembly may effectively protect the body 1 of the electrode-assembly in time.

In a specific example, coupling the current blocker 20 to the first electrode tab 11 can be achieved by the following methods:

The first method: as shown in FIG. 3, the current blocker 20 is directly electrically connected to the first electrode tab 11; specifically, the first electrode tab 11 is adhered to the first wall 13, and the current blocker 20 is welded to the portion of the first electrode tab 11 that covers the first wall 13.

The second method: as shown in FIG. 2, the electrode-assembly further includes a first connection terminal 21, the current blocker 20 is electrically connected to the first connection terminal 21, and the first connection terminal 21 is electrically connected to the first electrode tab 11, i.e., the current blocker 20 is connected to the first electrode tab 11 through the first connection terminal 21.

The third method: as shown in FIG. 1, the electrode-assembly further includes a connecting sheet 23, the first connection terminal 21 is electrically connected to the connecting sheet 23, and the connecting sheet 23 is electrically connected to the first electrode tab 11, i.e., the connecting sheet 23 is connected between the first connection terminal 21 and the first electrode tab 11.

The electrode-assembly may further include a second connection terminal 22 therein, the second connection terminal 22 is coupled to the current blocker 20, and the first connection terminal 21 and the second connection terminal 22 are connected by the current blocker 20 to form a current path for being connected into the charge and discharge circuit of the electrode-assembly body 1.

The electrode-assembly may also include a transfer sheet 24, and the transfer sheet 24 is coupled to the second connection terminal 22 for conducting the charge and discharge current to the external electrical device.

In an embodiment of the present application, the connecting path of the current blocker 20 to the first electrode tab 11 is connected by welding, such as laser welding or resistance welding; and the weld area of each weld zone is not less than 10% of the overlap area of the two weld bodies in the weld zone.

As shown in FIG. 1, when the current blocker 20 is connected to the first electrode tab 11 through the first connection terminal 21 and the connecting sheet 23, there are two weld zones on the connecting path of the current blocker 20 to the first electrode tab 11, which are respectively a weld zone between the first connection terminal 21 and the connecting sheet 23 and a weld zone between the connecting sheet 23 and the first electrode tab 11. At this time, in the two weld zones, the number of welding joints in each weld zone may be greater than four, as long as the weld area in each weld zone may reach 10% or more of the overlap area of the two weld bodies.

As shown in FIG. 1, in a specific example, both the first connection terminal 21 and the connecting sheet 23 may be made of a copper (Cu) material. The thermal conductivity of Cu is relatively high. Specifically, the thermal conductivity of Cu may reach 377 W/mK at 100° C., and the thermal conductivity from the first connection terminal 21 and the connecting sheet 23 to the inside of the current blocker 20 may be greatly improved.

In another specific example, a material having a higher thermal conductivity such as carbite, graphite or silicon material may be coated to the surfaces of the first connection terminal 21 and the connecting sheet 23 to allow heat to be conducted to the inside of the current blocker 20 more efficiently. Or, the outer portion of the first connection terminal 21, the outer portion of the connecting sheet 23, and the outer portion of the first electrode tab 11 are all covered with a porous material layer; that is, the thermally conductive path of the body 1 to the current blocker 20 is externally coated with a porous material layer. The porous material has a good thermal insulation performance, and coating the thermally conductive path of the body 1 to the current blocker 20 using the porous material may reduce the heat loss along the thermally conductive path effectively so as to facilitate the conduction of heat to the inside of the current blocker 20 more effectively.

As shown in FIGS. 1 to 4, in a specific example, the current blocker 20 may include a PTC (Positive Temperature Coefficient) thermistor. The PTC thermistor is a typical temperature-sensitive semiconductor resistor. When the temperature of PTC thermistor (Curie temperature) is exceeded, the resistance of PTC thermistor increases stepwise. For example, the ceramic PTC thermistor has a small resistance below the Curie temperature, and the resistance step above the Curie temperature is increased by 1000 times to a million times.

Specifically, when the current blocker 20 is not triggered, the charge and discharge current of the electrode-assembly body 1 does not pass through the PTC thermistor, that is, the PTC thermistor is not connected to the charge and discharge circuit of the electrode-assembly body 1. However, when the current blocker 20 is triggered, the PTC thermistor is connected to the charge and discharge circuit of the electrode-assembly body 1, so that the resistance in the charge and discharge circuit is greatly increased, and the charge and discharge circuit is further reduced significantly, even close to zero, thereby protecting the electrode-assembly.

In another specific example, the current blocker 20 may include a thermoswitch, such as a metal dome switch; specifically, when the current blacker 20 is not triggered, the thermoswitch is in a closed state, allowing the charge and discharge current to pass; when the current blocker 20 is triggered, the thermoswitch is turned off to cause the charge and discharge current to be cut off for protecting the electrode-assembly.

Still or, the current blocker 20 may also include a current fuse; specifically, when the temperature exceeds a certain temperature, the current fuse is blown, thereby cutting off the charge and discharge current for protecting the electrode-assembly.

In a specific example, an opening is formed in a side of the housing of the current blocker 20 close to the first wall 13 to expose a protection circuit inside the current blocker 20, and the protection circuit is a circuit in the current blocker 20 connected in series with the body 1 and belongs to a part of the charge and discharge circuit of the electrode-assembly body 1. Therefore, the heat of the body 1 may be directly conducted to the protection circuit through the first wall 13, so that the current blocker 20 may be triggered to reduce or cut off the charge and discharge current in time for achieving effective protection of the electrode-assembly.

In addition, examples of the present application further provide a battery including the electrode-assembly according to any one of above examples.

Subsequently, taking an electrode-assembly with a capacitance of 3 Ah as an example, the electrode-assemblies in the following examples are overcharge tested, and the safety of each electrode-assembly is analyzed through test results; overcharge refers to a critical state in which the temperature of the electrode-assembly body rises to a combustion or explosion reaction. Specifically, the operation of the overcharge test is performed by overcharging to 12 V at a rate of 1 C and holding for 2 hours at a voltage of 12 V.

The specific conditions of each electrode-assembly are as follows:

Comparative Example: the current blocker is adhered to the first side of the electrode-assembly body; the current blocker is electrically connected to the first connection terminal, the first connection terminal is electrically connected to the connecting sheet, and the connecting sheet is electrically connected to the first electrode tab.

Example 1: the current blocker is adhered to the first wall of the electrode-assembly body; the current blocker is electrically connected to the first connection terminal, the first connection terminal is electrically connected to the connecting sheet, and the connecting sheet is electrically connected to the first electrode tab.

Example 2: the current blocker is adhered to the first wall of the electrode-assembly body; the current blocker is directly electrically connected to the first electrode tab.

Table 1 shows the test results of the overcharge pass rate for each electrode-assembly, wherein the denominator in each data is the number of overcharge tests and the numerator is the number of the overcharge test passes. As can be seen from Table 1, the overcharge test pass rate of electrode-assemblies provided by the examples of the present application (Examples 1 to 2) is significantly improved compared with the overcharge test pass rate of the conventional electrode-assemblies in the prior art (Comparative Example). Therefore, it can be seen from the test results that the current blockers of the electrode-assembly provided by the examples of the present application (Examples 1 and 2) may be triggered in a more timely manner, and may prevent the electrode-assembly body from reaching the over-charge state effectively, so that the electrode-assembly may be protected more effectively.

TABLE 1

| | | | Comparative |
|---|---|---|---|
| Groups | Example 1 | Example 2 | Examples |
| overcharge pass | 8/10 | 10/10 | 1/10 |
| rate | | | |

It will be apparent to those skilled in the art that various modifications and variations of examples of the present application can be made without departing from the spirit or scope of the application. If these various modifications and variations of the present application belong to the scope of the claim and equivalent technical scope, the application is intended to include these modifications and variations.

What is claimed is:

1. An electrode-assembly, comprising:
a body comprising a first wall and a first side, the first side is adjacent to the first wall; and
a current blocker arranged on the first wall.

2. The electrode-assembly according to claim 1, wherein the current blocker comprises a housing, and an opening of the housing faces the first wall.

3. The electrode-assembly according to claim 1, wherein the current blocker is adhered to the first wall.

4. The electrode-assembly according to claim 1, wherein the body further comprises a first electrode tab, the first electrode tab protrudes from the first side, and the current blocker is coupled to the first electrode tab.

5. The electrode-assembly according to claim 4, wherein the first electrode tab is adhered to at least one of the first wall and the first side.

6. The electrode-assembly according to claim 4, wherein the current blocker is triggered at a first temperature to reduce a current passing through;
a product of a length of a connecting path from the current blocker to the first electrode tab and a cooling coefficient of the connecting path is smaller than a difference between a second temperature of the first electrode tab and the first temperature.

7. The electrode-assembly according to claim 6, wherein the current blocker is directly electrically connected to the first electrode tab.

8. The electrode-assembly according to claim 6, further comprising a first connection terminal, the current blocker is electrically connected to the first connection terminal, and the first connection terminal is electrically connected to the first electrode tab.

9. The electrode-assembly according to claim 8, further comprising a connecting sheet, the first connection terminal is electrically connected to the connecting sheet, and the connecting sheet is electrically connected to the first electrode tab.

10. The electrode-assembly according to claim 9, wherein the path of the current blocker to the first electrode tab is connected by welding, and the weld area of each weld zone is not less than 10% of the overlap area of the two weld bodies in the weld zone.

11. The electrode-assembly according to claim 9, wherein the materials of the first connection terminal and the connecting sheet are copper.

12. The electrode-assembly according to claim 9, wherein a surface of the first connection terminal and the connecting sheet are coated with at least one of carbite, graphite, and silicon material.

13. The electrode-assembly according to claim 9, wherein at least one of an outer portion of the first connection terminal, an outer portion of the connecting sheet, and an outer portion of the first electrode tab is covered with a porous material layer.

14. The electrode-assembly according to claim 1, wherein the first side is a seal side perpendicularly connected to the first wall.

15. A battery, comprising a circuit protection board and the electrode-assembly according to claim 1.

16. The battery according to claim 14, wherein the current blocker comprises a housing, and an opening of the housing faces the first wall.

17. The battery according to claim 14, wherein the current blocker is adhered to the first wall.

18. The battery according to claim 14, wherein the body further comprises a first electrode tab, the first electrode tab protrudes from the first side, the current blocker is coupled to the first electrode tab.

19. The battery according to claim 17, wherein the first electrode tab is adhered to at least one of the first wall and the first side.

20. The battery according to claim 17, wherein the current blocker is triggered at a first temperature to reduce a current passing through;
a product of a length of a connecting path from the current blocker to the first electrode tab and a cooling coefficient of the connecting path is smaller than a difference between a second temperature of the first electrode tab and the first temperature.
